(19) United States
(12) Patent Application Publication
(10) Pub. No.: US 2026/0074246 A1
(43) Pub. Date: Mar. 12, 2026

(54) FUEL CELL MODULE

(71) Applicant: TOYOTA JIDOSHA KABUSHIKI KAISHA, Toyota-shi (JP)

(72) Inventor: Masaaki MATSUSUE, Mishima-shi (JP)

(73) Assignee: TOYOTA JIDOSHA KABUSHIKI KAISHA, Toyota-shi (JP)

(21) Appl. No.: 19/303,614

(22) Filed: Aug. 19, 2025

(30) Foreign Application Priority Data
Sep. 11, 2024 (JP) 2024-157280

(51) Int. Cl. H01M 8/04119; H01M 8/04082; H01M 8/2457; H01M 8/2483; H01M 8/2484

(52) U.S. Cl. CPC H01M 8/04164; H01M 8/04201; H01M 8/2457; H01M 8/2483; H01M 8/2484

(57) ABSTRACT

A fuel cell module includes a fuel cell stack made up of a plurality of stacked fuel-cell cells, a fuel gas outlet manifold that extends inside the fuel cell stack in a stacking direction, and through which a fuel gas that has passed through each of the fuel-cell cells flows, an oxidant gas outlet manifold that extends inside the fuel cell stack in the stacking direction, and through which an oxidant gas that has passed through each of the fuel-cell cells flows, a discharge flow passage that discharges the oxidant gas from the oxidant gas outlet manifold, a pressure regulating valve provided in the discharge flow passage, the pressure regulating valve being configured to lower a pressure in the discharge flow passage downstream from the pressure regulating valve than a pressure in the oxidant gas outlet manifold, and a water drain flow passage.

### CROSS-REFERENCE TO RELATED APPLICATION

This application claims priority to Japanese Patent Application No. 2024-157280 filed on Sep. 11, 2024. The disclosure of the above-identified application, including the specification, drawings, and claims, is incorporated by reference herein in its entirety.

### BACKGROUND

### 1. Technical Field

The technology disclosed in the present specification relates to a fuel cell module.

### 2. Description of Related Art

A fuel cell module disclosed in Japanese Unexamined Patent Application Publication No. 2020-155212 (JP 2020-155212 A) includes a fuel cell stack made up by stacking a plurality of fuel-cell cells. The fuel cell stack generates electricity by reacting a fuel gas with an oxidant gas. A fuel gas outlet manifold that discharges the fuel gas that has passed through the fuel-cell cells is provided inside the fuel cell stack. Further, an oxidant gas outlet manifold that discharges the oxidant gas that has passed through the fuel-cell cells is provided inside the fuel cell stack.

### SUMMARY

In the fuel cell stack, water is generated by the reaction between the fuel gas and the oxidant gas (hereinafter referred to as “generated water”). The generated water is discharged to the outside of the fuel cell stack via the fuel gas outlet manifold and the oxidant gas outlet manifold.

The fuel cell module may be provided with a water drain flow passage that discharges the generated water from the fuel gas outlet manifold to the oxidant gas outlet manifold. When the water drain flow passage is provided, the discharge paths of the generated water can be unified between the fuel gas outlet manifold and the oxidant gas outlet manifold. However, when the water drain flow passage is provided in this manner, the generated water and the oxidant gas may flow backward in the water drain flow passage. The present specification proposes a technique that suppresses flowing backward in a water drain flow passage.

### First Aspect

In a fuel cell module disclosed in the present specification includes a fuel cell stack made up of a plurality of stacked fuel-cell cells, a fuel gas outlet manifold that extends inside the fuel cell stack in a stacking direction, and through which a fuel gas that has passed through each of the fuel-cell cells flows, an oxidant gas outlet manifold that extends inside the fuel cell stack in the stacking direction, and through which an oxidant gas that has passed through each of the fuel-cell cells flows, a discharge flow passage that discharges the oxidant gas from the oxidant gas outlet manifold, a pressure regulating valve provided in the discharge flow passage, the pressure regulating valve being configured to lower a pressure in the discharge flow passage downstream from the pressure regulating valve than a pressure in the oxidant gas outlet manifold, and a water drain flow passage that discharges water generated within the fuel-cell cells from the fuel gas outlet manifold to the discharge flow passage downstream from the pressure regulating valve.

In the fuel cell module described above, the water drain flow passage discharges the generated water from the fuel gas outlet manifold to the discharge flow passage downstream from the pressure regulating valve. The pressure in the discharge flow passage downstream from the pressure regulating valve is controlled by the pressure regulating valve to be lower than the pressure in the oxidant gas outlet manifold. As a result, flowing backward in the water drain flow passage is able to be suppressed.

Following the first aspect described above, additional configurations of the fuel cell system disclosed in the present specification will be described below.

### Second Aspect

In the fuel cell module according to the first aspect, a gas-liquid separator is further included, the fuel cell stack is provided with a first end surface on one side in the stacking direction and a second end surface on another side in the stacking direction, the fuel gas outlet manifold includes a fuel gas discharge port on the first end surface, the oxidant gas outlet manifold includes an oxidant gas discharge port on the second end surface, the oxidant gas discharge port being connected to the discharge flow passage, the gas-liquid separator separates the water from the fuel gas discharged from the fuel gas discharge port, and the water drain flow passage is configured to discharge the water separated in the gas-liquid separator to the discharge flow passage downstream from the pressure regulating valve, and extends from the gas-liquid separator through the first end surface, through the oxidant gas outlet manifold, and to the discharge flow passage.

### Third Aspect

In the fuel cell module according to the first or second aspect, the fuel cell stack is provided with a first end surface on one side in the stacking direction and a second end surface on another side in the stacking direction, the fuel gas outlet manifold includes a fuel gas discharge port on the first end surface, the oxidant gas outlet manifold includes an oxidant gas discharge port on the second end surface, the oxidant gas discharge port being connected to the discharge flow passage, and the water drain flow passage extends from an upstream end portion of the fuel gas outlet manifold to the discharge flow passage downstream from the pressure regulating valve.

### Fourth Aspect

In the fuel cell module according to any one of the first to third aspects, a water drain pipe extending along the stacking direction is provided within the oxidant gas outlet manifold.

According to the second aspect, the water drain flow passage that discharges the water separated by the gas-liquid separator extends through the oxidant gas outlet manifold to the discharge flow passage. Therefore, the flow passage length of the water drain flow passage is able to be shortened, and the fuel cell module is able to be made smaller.

According to the third aspect, the water accumulated at the upstream end portion of the fuel gas outlet manifold is discharged through the water drain flow passage to the discharge flow passage downstream from the pressure regulating valve. Therefore, within the fuel gas outlet manifold, the discharge of the water is promoted by the water drain flow passage.

According to the fourth aspect, the generated water in the oxidant gas outlet manifold is able to be easily discharged.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a fuel cell module according to a first embodiment;

FIG. 2 is a schematic diagram of a fuel cell module according to a second embodiment;

FIG. 3 is a schematic diagram of a fuel cell module according to a third embodiment;

FIG. 4 is a schematic diagram of a fuel cell module according to a fourth embodiment; and

FIG. 5 is a schematic diagram of a fuel cell module according to a fifth embodiment.

### DETAILED DESCRIPTION OF EMBODIMENTS

### First Embodiment

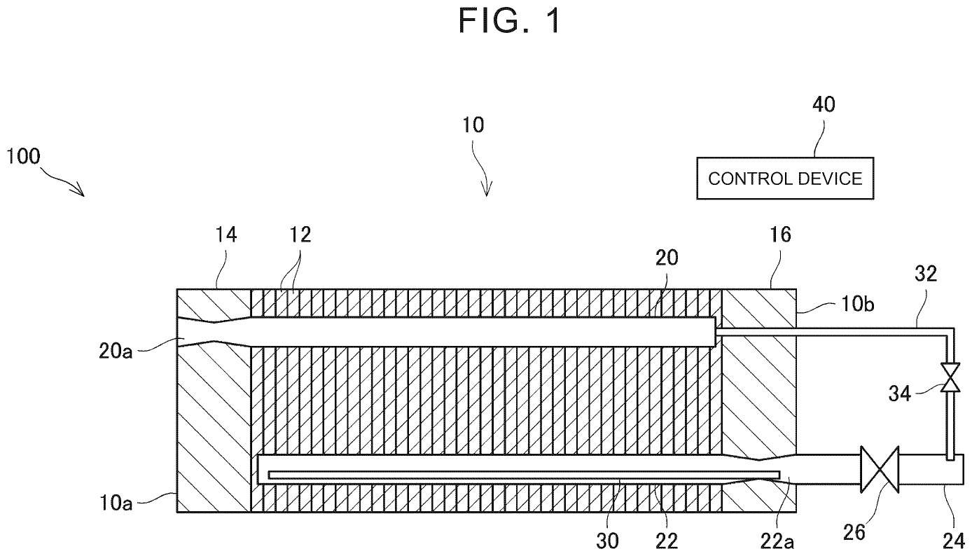

A fuel cell module 100 according to a first embodiment shown in FIG. 1 is mounted on a device powered by a fuel cell (for example, a fuel cell electric vehicle). The fuel cell module 100 includes a fuel cell stack 10. The fuel cell module 100 supplies electric power generated in the fuel cell stack 10 to a motor etc.

The fuel cell stack 10 includes a plurality of stacked fuel-cell cells 12 and end plates 14, 16. One end of the stack of the fuel-cell cells 12 is covered by the end plate 14, and the other end of the stack of the fuel-cell cells 12 is covered by the end plate 16. That is, the stack of the fuel-cell cells 12 is sandwiched between the end plates 14, 16 in the stacking direction. In the following description, the end surface on the end plate 14 side is referred to as a first end surface 10a, and the end surface on the end plate 16 side is referred to as a second end surface 10b in the fuel cell stack 10.

An oxidant gas (for example, air) is supplied to each of the fuel-cell cells 12 from a manifold (not shown), and a fuel gas (for example, hydrogen) is supplied to each of the fuel-cell cells 12 from a manifold (not shown). Each of the fuel-cell cells 12 generates electricity by reacting the fuel gas with the oxidant gas. As a result of the reaction, water is generated in each of the fuel-cell cells 12 (hereinafter referred to as “generated water”). As shown in FIG. 1, a fuel gas outlet manifold 20 and an oxidant gas outlet manifold 22 are provided inside the fuel cell stack 10.

The fuel gas outlet manifold 20 extends through each of the fuel-cell cells 12 and the end plate 14 inside the fuel cell stack 10 in the stacking direction. The fuel gas outlet manifold 20 includes a fuel gas discharge port 20a. The fuel gas discharge port 20a opens to the first end surface 10a. The fuel gas that has passed through the inside of each of the fuel-cell cells 12 flows through the fuel gas outlet manifold 20. The fuel-cell cells 12 discharge the generated water together with the fuel gas to the fuel gas outlet manifold 20. The generated water and the fuel gas flow through the fuel gas outlet manifold 20, and are discharged to the outside of the fuel cell stack 10 via the fuel gas discharge port 20a.

The oxidant gas outlet manifold 22 extends through each of the fuel-cell cells 12 and the end plate 16 inside the fuel cell stack 10 in the stacking direction. The oxidant gas outlet manifold 22 includes an oxidant gas discharge port 22a. The oxidant gas discharge port 22a opens to the second end surface 10b. The oxidant gas that has passed through each of the fuel-cell cells 12 flows through the oxidant gas outlet manifold 22. The fuel-cell cells 12 discharge the generated water together with the oxidant gas to the oxidant gas outlet manifold 22. The oxidant gas and the generated water flow through the oxidant gas outlet manifold 22 toward the oxidant gas discharge port 22a.

A water drain pipe 30 is provided within the oxidant gas outlet manifold 22. The water drain pipe 30 is a pipe that is thinner than the oxidant gas outlet manifold 22 and its both ends are released. The water drain pipe 30 extends from the upstream end portion (i.e., the first end surface 10a side) of the oxidant gas outlet manifold 22 to the oxidant gas discharge port 22a. That is to say, the water drain pipe 30 extends along the stacking direction of the fuel-cell cells 12. When the generated water accumulates at the upstream end portion of the oxidant gas outlet manifold 22, the generated water is discharged through the water drain pipe 30 to the oxidant gas discharge port 22a. Therefore, within the oxidant gas outlet manifold 22, the discharge of the generated water is promoted by the water drain pipe 30.

The fuel cell module 100 includes a discharge flow passage 24. The upstream end of the discharge flow passage 24 is connected to the oxidant gas discharge port 22a. The oxidant gas and the generated water flowing through the oxidant gas outlet manifold 22 are discharged to the outside of the fuel cell stack 10 via the discharge flow passage 24. The discharge flow passage 24 is provided with a pressure regulating valve 26. The fuel cell module 100 includes a control device 40. The control device 40 controls the pressure regulating valve 26. The control device 40 controls the pressure regulating valve 26 to lower the pressure in the discharge flow passage 24 downstream from the pressure regulating valve 26 than the pressure in the oxidant gas outlet manifold 22.

The fuel cell module 100 includes a water drain flow passage 32. The water drain flow passage 32 is a flow passage narrower than the fuel gas outlet manifold 20 and the oxidant gas outlet manifold 22. The upstream end of the water drain flow passage 32 is connected to the upstream end portion of the oxidant gas outlet manifold 22 (i.e., the second end surface 10b side). The water drain flow passage 32 penetrates the end plate 16 and extends to the discharge flow passage 24. The downstream end of the water drain flow passage 32 is connected to the discharge flow passage 24 downstream from the pressure regulating valve 26. The water drain flow passage 32 is provided with a valve 34. The valve 34 opens and closes the flow passage of the water drain flow passage 32. When the valve 34 is in an open state and the generated water accumulates at the upstream end portion of the fuel gas outlet manifold 20, the generated water is discharged through the water drain flow passage 32 to the discharge flow passage 24. The water drain flow passage 32 promotes the discharge of the generated water from the fuel gas outlet manifold 20.

As described above, during operation of the fuel cell module 100, the fuel gas and the generated water are discharged from the fuel gas outlet manifold 20 to the outside of the fuel cell stack 10 via the fuel gas discharge port 20a, and the oxidant gas and the generated water are discharged from the oxidant gas outlet manifold 22 to the outside of the fuel cell stack 10 via the discharge flow passage 24. During operation of the fuel cell module 100, the valve 34 is controlled to be in the open state. Therefore, when the generated water accumulates in the fuel gas outlet manifold 20, the generated water in the fuel gas outlet manifold 20 is discharged through the water drain flow passage 32 to the discharge flow passage 24. At this time, since the pressure in the discharge flow passage 24 downstream from the pressure regulating valve 26 is controlled by the pressure regulating valve 26 to be lower than the pressure in the oxidant gas outlet manifold 22, the pressure at the outlet of the water drain flow passage 32 is low. Therefore, the oxidant gas and the generated water are restrained from flowing backward from the discharge flow passage 24 to the water drain flow passage 32. Therefore, the generated water in the fuel gas outlet manifold 20 is suitably discharged to the discharge flow passage 24.

### Second Embodiment

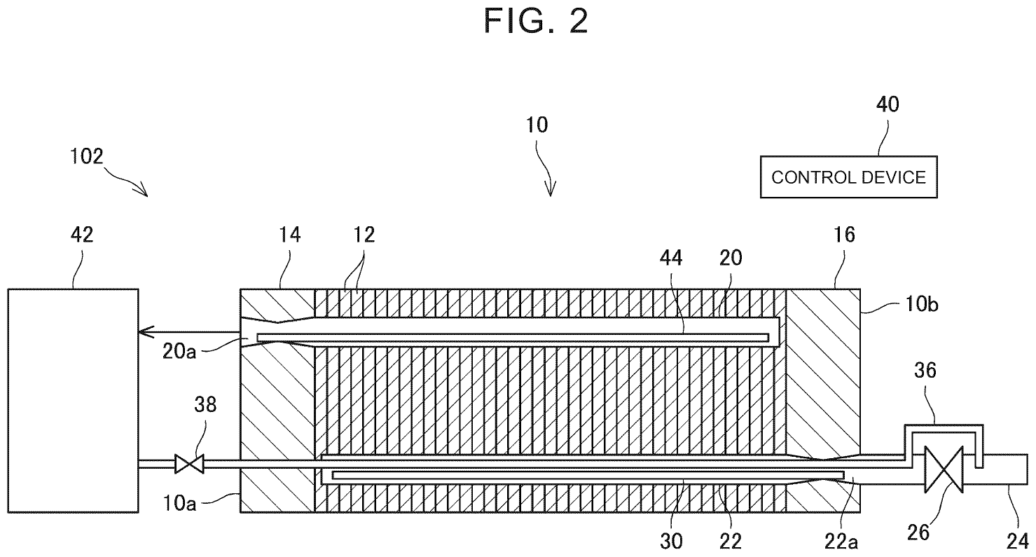

FIG. 2 shows a fuel cell module 102 according to a second embodiment. In FIG. 2, parts common to those in FIG. 1 are denoted by the same reference signs. The fuel cell module 102 of the second embodiment differs from the fuel cell module of the first embodiment in that it does not include the water drain flow passage 32 and it includes a water drain pipe 44, a gas-liquid separator 42, and a water drain flow passage 36. In other respects, the fuel cell module 102 of the second embodiment is the same as the fuel cell module of the first embodiment.

The gas-liquid separator 42 is disposed next to the end plate 14. The gas-liquid separator 42 is connected to the fuel gas discharge port 20a. The generated water and the fuel gas discharged from each of the fuel-cell cells 12 flow through the fuel gas outlet manifold 20, and are discharged to the gas-liquid separator 42 via the fuel gas discharge port 20a. The gas-liquid separator 42 separates the fuel gas from the generated water. The fuel gas separated from the generated water by the gas-liquid separator 42 is resupplied to the fuel cell stack 10 through a fuel gas supply path (not shown).

The water drain pipe 44 is provided within the fuel gas outlet manifold 20. The water drain pipe 44 is a pipe that is thinner than the fuel gas outlet manifold 20 and its both ends are released. The water drain pipe 44 extends from the upstream end portion (i.e., the second end surface 10b side) of the fuel gas outlet manifold 20 to the fuel gas discharge port 20a. That is to say, the water drain pipe 44 extends along the stacking direction of the fuel-cell cells 12. When the generated water accumulates at the upstream end portion of the fuel gas outlet manifold 20, the generated water flows through the water drain pipe 44 and is discharged to the gas-liquid separator 42 via the fuel gas discharge port 20a. Within the fuel gas outlet manifold 20, the discharge of the generated water is promoted by the water drain pipe 44.

The fuel cell module 102 includes the water drain flow passage 36 made up of a thin pipe. The water drain flow passage 36 is a flow passage narrower than the fuel gas outlet manifold 20 and the oxidant gas outlet manifold 22. The upstream end of the water drain flow passage 36 is connected to the gas-liquid separator 42. The water drain flow passage 36 extends from the gas-liquid separator 42 through the first end surface 10a into the oxidant gas outlet manifold 22. The water drain flow passage 36 extends through the inside of the oxidant gas outlet manifold 22 to the oxidant gas discharge port 22a. The water drain flow passage 36 is led out from the discharge flow passage 24 to the outside. The downstream end of the water drain flow passage 36 is connected to the discharge flow passage 24 downstream from the pressure regulating valve 26. The water drain flow passage 36 is provided with a valve 38. The valve 38 opens and closes the flow passage of the water drain flow passage 36. When the valve 38 is open, the generated water separated from the fuel gas by the gas-liquid separator 42 is discharged to the discharge flow passage 24 via the water drain flow passage 36.

During operation of the fuel cell module 102 of the second embodiment, the oxidant gas and the generated water are discharged from the oxidant gas outlet manifold 22 through the discharge flow passage 24 to the outside of the fuel cell stack 10, similar to the first embodiment. During operation of the fuel cell module 102, the fuel gas and the generated water are discharged from the fuel gas outlet manifold 20 to the gas-liquid separator 42, as described above. Further, during operation of the fuel cell module 102, the valve 38 is controlled to be in the open state. As a result, the generated water in the gas-liquid separator 42 is discharged to the discharge flow passage 24 via the water drain flow passage 36. That is, the water drain flow passage 36 discharges the generated water generated within the fuel-cell cells 12 from the fuel gas outlet manifold 20 to the discharge flow passage 24 downstream from the pressure regulating valve 26. Since the pressure in the discharge flow passage 24 downstream from the pressure regulating valve 26 is controlled by the pressure regulating valve 26 to be lower than the pressure in the oxidant gas outlet manifold 22, the pressure at the outlet of the water drain flow passage 36 is low. Therefore, the oxidant gas and the generated water are restrained from flowing backward from the discharge flow passage 24 to the water drain flow passage 36.

In the second embodiment, as described above, the water drain flow passage 36 is provided so as to pass through the oxidant gas outlet manifold 22. According to the configuration, the flow passage length of the water drain flow passage 36 is able to be shortened than when the water drain flow passage 36 is provided outside the fuel cell stack 10, and the fuel cell module 102 is able to be made smaller.

### Third Embodiment

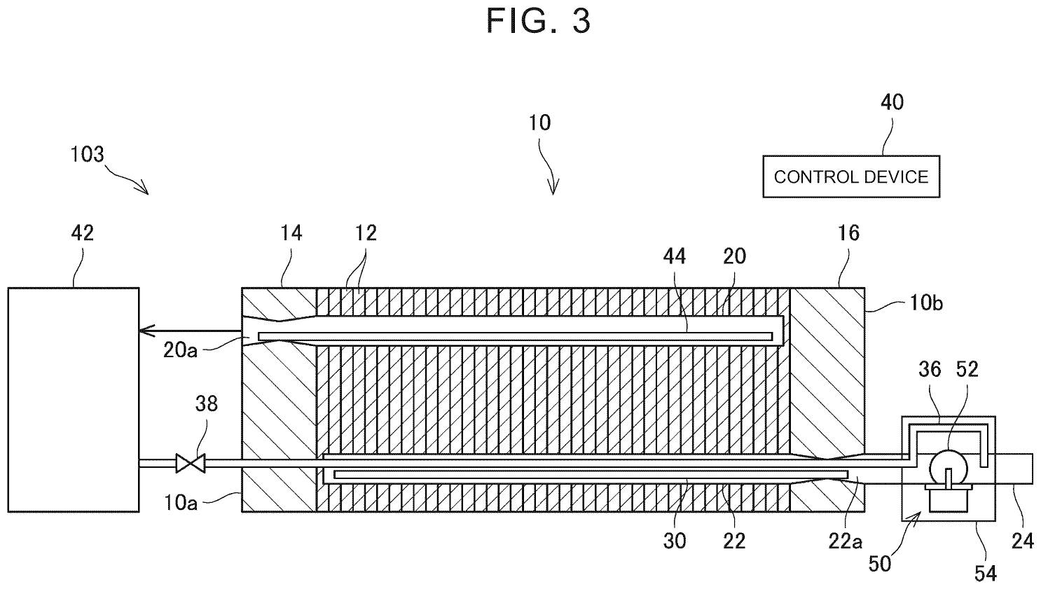

A fuel cell module 103 according to a third embodiment shown in FIG. 3 differs from the fuel cell module of the second embodiment in terms of the pressure regulating valve. Further, the fuel cell module 103 of the third embodiment differs from the fuel cell module of the second embodiment in terms of the arrangement of the downstream side portion of the water drain flow passage 36. Other configurations of the fuel cell module 103 of the third embodiment are the same as the fuel cell module of the second embodiment.

In the third embodiment, the fuel cell module 103 includes a pressure regulating valve 50. The pressure regulating valve 50 is a butterfly valve provided with a valve body 52. The pressure regulating valve 50 is housed in a housing 54. The downstream side portion of the water drain flow passage 36 passes through the housing 54 and extends to the discharge flow passage 24. In the third embodiment as well, the downstream end of the water drain flow passage 36 is connected to the discharge flow passage 24 downstream from the pressure regulating valve. Therefore, the generated water can be discharged by the water drain flow passage 36 while the flowing backward in the water drain flow passage 36 is restrained.

### Fourth Embodiment

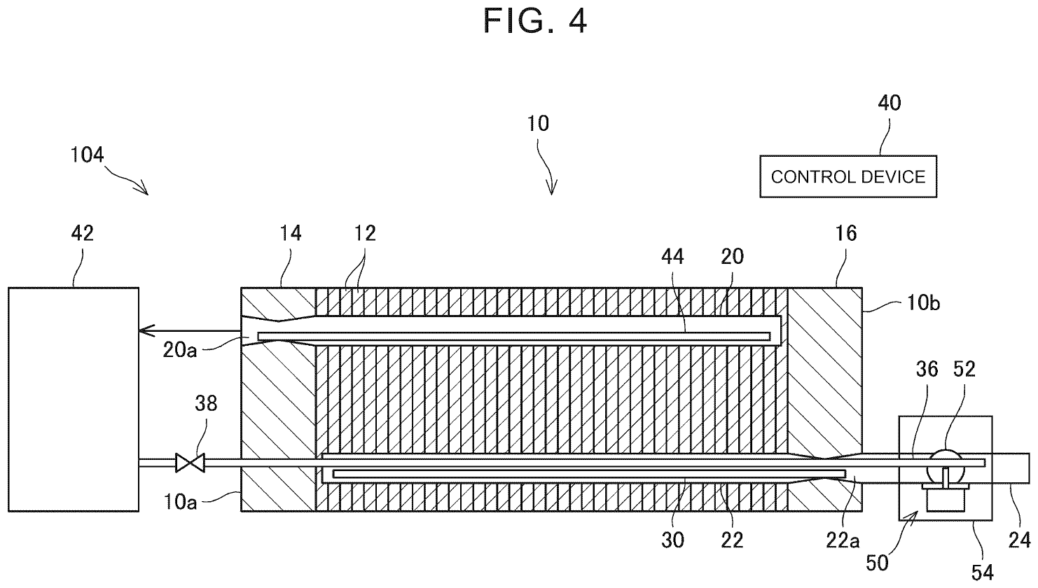

In the third embodiment described above, the downstream side portion of the water drain flow passage 36 passes through the housing 54 and extends to the discharge flow passage 24. In contrast, as shown in FIG. 4, in a fuel cell module 104 of a fourth embodiment, the water drain flow passage 36 extends from the gas-liquid separator 42 through the oxidant gas outlet manifold 22 and the valve body 52 to the discharge flow passage 24. In the fourth embodiment as well, the downstream end of the water drain flow passage 36 is connected to the discharge flow passage 24 downstream from the pressure regulating valve. Therefore, the generated water can be discharged by the water drain flow passage 36 while the flowing backward in the water drain flow passage 36 is restrained.

### Fifth Embodiment

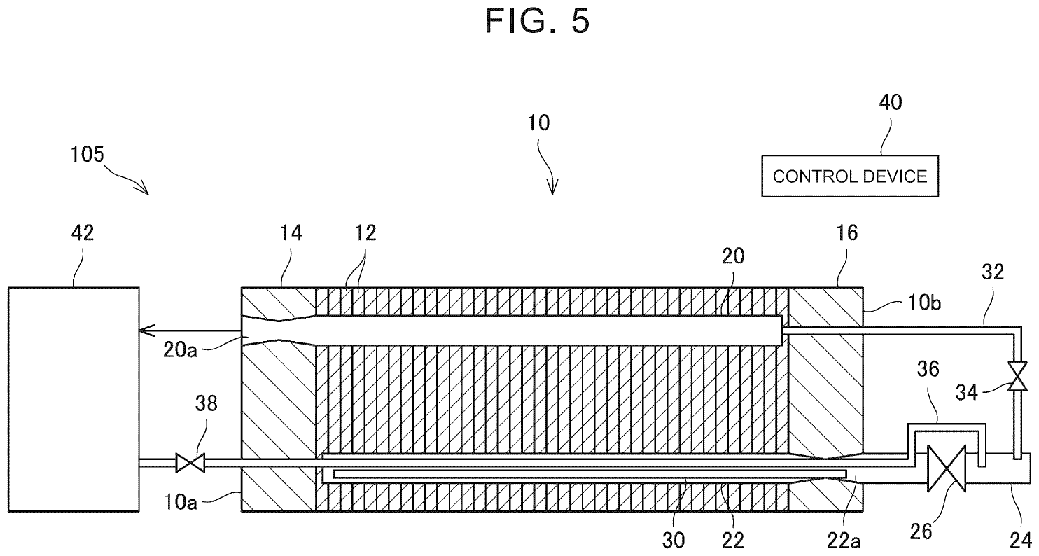

In the configuration of a fuel cell module 105 according to a fifth embodiment shown in FIG. 5, the first and second embodiments are combined. In this case, the water drain pipe 44 does not need to be provided.

In the first to fifth embodiments, the fuel gas discharge port 20a is opened to the first end surface 10a. However, the fuel gas discharge port 20a may be opened to the second end surface 10b. Further, in the first and second embodiments, the oxidant gas discharge port 22a is opened to the second end surface 10b. However, the oxidant gas discharge port 22a may be opened to the first end surface 10a.

In the first to fifth embodiments, the water drain pipe 30 is provided within the oxidant gas outlet manifold 22. However, the water drain pipe 30 does not need to be provided within the oxidant gas outlet manifold 22.

In the second to fourth embodiments, the water drain pipe 44 is provided within the fuel gas outlet manifold 20. However, the water drain pipe 44 does not need to be provided within the fuel gas outlet manifold 20.

In the first and fifth embodiments, the water drain flow passage 32 is provided with the valve 34. However, the water drain flow passage 32 does not need to be provided with the valve 34. In this case, the water drain flow passage 32 may be always released.

In the second to fifth embodiments, the water drain flow passage 36 is provided with the valve 38. However, the water drain flow passage 36 does not need to be provided with the valve 38. In this case, the water drain flow passage 36 may be always released.

Although the embodiments have been described in detail above, these are merely examples and do not limit the scope of the claims. The technique described in the claims includes various modifications and variations of the specific examples exemplified above. The technical elements described in the present specification or in the drawings exhibit technical usefulness alone or in various combinations, and are not limited to the combinations described in the claims at the time of filing the application. In addition, the technique exemplified in the present specification or in the drawings achieves a plurality of purposes at the same time, and achieving one of the purposes itself has technical usefulness.

What is claimed is:

1. A fuel cell module comprising:
a fuel cell stack made up of a plurality of stacked fuel-cell cells;
a fuel gas outlet manifold that extends inside the fuel cell stack in a stacking direction, and through which a fuel gas that has passed through each of the fuel-cell cells flows;
an oxidant gas outlet manifold that extends inside the fuel cell stack in the stacking direction, and through which an oxidant gas that has passed through each of the fuel-cell cells flows;
a discharge flow passage that discharges the oxidant gas from the oxidant gas outlet manifold;
a pressure regulating valve provided in the discharge flow passage, the pressure regulating valve being configured to lower a pressure in the discharge flow passage downstream from the pressure regulating valve than a pressure in the oxidant gas outlet manifold; and
a water drain flow passage that discharges water generated within the fuel-cell cells from the fuel gas outlet manifold to the discharge flow passage downstream from the pressure regulating valve.

2. The fuel cell module according to claim 1, further comprising a gas-liquid separator, wherein:
the fuel cell stack is provided with a first end surface on one side in the stacking direction and a second end surface on another side in the stacking direction;
the fuel gas outlet manifold includes a fuel gas discharge port on the first end surface;
the oxidant gas outlet manifold includes an oxidant gas discharge port on the second end surface, the oxidant gas discharge port being connected to the discharge flow passage;
the gas-liquid separator separates the water from the fuel gas discharged from the fuel gas discharge port; and
the water drain flow passage is configured to discharge the water separated in the gas-liquid separator to the discharge flow passage downstream from the pressure regulating valve, and extends from the gas-liquid separator through the first end surface, through the oxidant gas outlet manifold, and to the discharge flow passage.

3. The fuel cell module according to claim 1, wherein:
the fuel cell stack is provided with a first end surface on one side in the stacking direction and a second end surface on another side in the stacking direction;
the fuel gas outlet manifold includes a fuel gas discharge port on the first end surface;
the oxidant gas outlet manifold includes an oxidant gas discharge port on the second end surface, the oxidant gas discharge port being connected to the discharge flow passage; and
the water drain flow passage extends from an upstream end portion of the fuel gas outlet manifold to the discharge flow passage downstream from the pressure regulating valve.

4. The fuel cell module according to claim 1, wherein a water drain pipe extending along the stacking direction is provided within the oxidant gas outlet manifold.
